(19) United States
(12) Patent Application Publication
(10) Pub. No.: US 2017/0060058 A1
(43) Pub. Date: Mar. 2, 2017

(54) FIXING DEVICE USING STAINLESS STEEL MATERIAL

(71) Applicant: K.K. ENDO SEISAKUSHO, Niigata-ken (JP)

(72) Inventors: Hiroyuki Toyama, Niigata (JP); Katsutoshi Maruyama, Niigata (JP); Takashi Yaoita, Niigata (JP)

(73) Assignee: K.K. ENDO SEISAKUSHO, Niigata-ken (JP)

(21) Appl. No.: 15/252,207

(22) Filed: Aug. 30, 2016

(30) Foreign Application Priority Data
Aug. 31, 2015 (JP) 2015-170453

(51) Int. Cl. B23P 6/00; G03G 15/20

(52) U.S. Cl. CPC G03G 15/2057; C23C 4/123

(57) ABSTRACT

A thin aluminum surface layer is formed on the outer peripheral surface of a tubular body of stainless steel material as a base layer to provide a fixing member. For forming the thin aluminum surface layer, arc thermal spraying apparatus is used such that material of a wire rod for thermal spraying is aluminum with purity of 99%, diameter of the wire rod is φ 1.2 mm, distance of thermal spraying is 120 mm, shifting velocity of the spraying gun is 20 mm/sec and air pressure is 0.5 MPa. Rotating the tubular body of stainless steel as a base layer at 150 rpm, thermal spraying of aluminum is performed with the spraying gun being shifted in the direction parallel to the axial direction of the tubular body of stainless steel as shown by the arrow. The thickness of the thermally sprayed aluminum surface layer is 20 to 30 μm.

### CROSS-REFERENCE TO RELATED APPLICATIONS

This application claims the priority benefit of Japanese application serial no. 2015-170453, filed on Aug. 31, 2015. The entirety of the above-mentioned patent application is hereby incorporated by reference herein and made a part of this specification.

### FIELD OF THE INVENTION

The present invention relates to a fixing device provided with a fixing member having a thin tubular shape using a stainless steel material and particularly relates to a fixing device provided with a fixing sleeve or fixing roller for fixing toner on a paper sheet by applying heat and pressure in a laser printer or copying machine.

### BACKGROUND OF THE INVENTION

The fixing method of a laser printer or copying machine is being changed from a conventional fixing method with a roller to one with a film. With the conventional fixing method with a roller, it is necessary to keep the heater operated even in time of waiting so as to heat the roller with the heater inside of the roller. In contrast to this, a fixing sleeve formed to have a small thickness enables power saving and shortening of waiting time since it has a high thermal conductivity and a small heat capacity and the heater is operated only when the fixing tube is rotated. While metal materials such as stainless steel or resin materials such as polyimide are used for the thin tube as the base layer of this fixing sleeve, metal materials such as stainless steel having high strength and small heat capacity are preferable in order to secure power saving or shortening of waiting time.

Flexibility in the circumferential direction bearable to deformation and durability are required for a fixing sleeve. In the case where a stainless steel material is used for a base layer, the base layer is formed so as to be extremely thin as a thickness of 20 μm to 50 μm. As a method for forming a such an extremely thin metal tube, it is known to use spinning (see Patent Document 1).

An extremely thin fixing sleeve using a stainless steel material is excellent in thermal responsiveness since it has a small heat capacity as the specific heat is small compared with a conventional fixing sleeve made of an aluminum material). Further, an extremely thin fixing sleeve using a stainless steel material has a thin thickness, so that temperature rising becomes fast in the direction of thickness. However, a fixing sleeve using a stainless steel material is inferior in thermal conductivity in its axial direction since thermal conductivity of the stainless steel sleeve is low compared with a conventional fixing sleeve made of an aluminum material. Furthermore, while a fixing sleeve is deprived of heat in the central portion in the axial direction, when paper is fed through, temperature is raised in the end portions in the axial direction. Accordingly, temperature is not even in the axial direction, thus giving a problem of so called thermal unevenness in a fixing sleeve.

There is a method of applying copper plating having a high thermal conductivity on the outer peripheral surface of a tubular body as a base layer made of a stainless steel material for solving thermal unevenness in a fixing sleeve. However, this method provides a problem such that it is not likely for the paint such as rubber to be securely attached to the peripheral surface of the sleeve plated with copper due to influence of oxidized copper surface layer.

There is another method of forming an extremely thin metal tubular body by spinning of a laminated material (a clad material) of stainless steel with copper or of stainless steel with aluminum for solving thermal unevenness in a fixing sleeve. However, this method provides a problem such that expense for manufacturing becomes higher since price of such a laminated material is high.

There is still another method of performing thermal spraying of aluminum having a high thermal conductivity on the outer peripheral surface of a tubular body as a base layer for solving thermal unevenness in a fixing sleeve (Patent Documents 1 to 4). Further, a halogen heater utilizing radiant heat radiated from a halogen lamp enables heating just after turning on of the power source switch and has stability, with low expense required. However, it is difficult to employ a halogen lamp for a thick fixing sleeve, since it has a large heat capacity to require time for raising the temperature of the fixing sleeve.

Regarding the fixing member disclosed in Patent Document 1, there is no disclosure of the thickness of the stainless steel material forming the base layer. Here, the thickness of the aluminum surface layer thermally sprayed thereon is more than 5 μm and the heating element disposed inside of the stainless steel tubular body is liquid heating medium 13 or a heater 15.

Regarding the fixing member disclosed in Patent Document 2, there is no disclosure of the thickness of the stainless steel material forming the base layer and the thickness of the aluminum surface layer thermally sprayed thereon. Further, there is no disclosure of the heating element disposed inside of the stainless steel tubular body. Regarding the fixing member disclosed in Patent Document 3, there is no disclosure of the thickness of the stainless steel material forming the base layer. Further, the thickness of the aluminum surface layer thermally sprayed thereon is 1.5 mm, thus not being a thin aluminum surface layer. Furthermore, the heating element disposed inside of the stainless steel tubular body is a coil 5 for electromagnetic induction.

While in the fixing member discloses in Patent Document 4, the thickness of the stainless steel material as a base layer is 30 μm to 200 μm, it is not disclosed that aluminum is thermally sprayed on the outer peripheral surface of the stainless steel as a base layer. Furthermore, the heating element disposed inside of the stainless steel tubular body is a ceramic heater 11.

### PRIOR ART DOCUMENT

### Patent Document

Patent Document 1: JP Publication of Patent Application No. S53-120537
Patent Document 2: JP Publication of Patent Application No. H08-95410

### Patent Document 3: JP Publication of Patent Application No. 2001-109307

### Patent Document 4: JP Publication of Patent Application No. 2003-156954

### SUMMARY OF THE INVENTION

The present invention provides a fixing device, in which temperature rising speed in the thickness direction is high, temperature distribution is uniform in the axial direction with little thermal unevenness on the fixing member and less energy is required for heating the fixing member, by forming a thin aluminum surface layer on the outer peripheral surface of a thin stainless steel tubular body as a base layer.

The fixing device using a stainless steel material according to the first aspect of the present invention is one using a stainless steel material for heating toner to fix toner images on recording media in an image forming apparatus in which copying is performed through toner;

the fixing device being equipped with a thin tubular fixing member heated by a heating element disposed therein, and

the thin tubular fixing member being formed through:
a step of forming a cup-shaped tubular body of stainless steel material having a thickness of 20 μm to 300 μm by fitting a mandrel into an inner peripheral surface of the cup-shaped tubular body of stainless steel material and performing spinning with a roller/rollers pressed and shifted in the axial direction during rotation of the cup-shaped tubular body to elongate the cup-shaped tubular body in the axial direction,
a step of cutting off both ends of the cup-shaped tubular body to form a tubular body of stainless steel material as a base layer, a step of aluminum thermal spraying on an outer peripheral surface of the tubular body of stainless steel material to form an aluminum surface layer having a thickness of 10 μm to 150 μm thereon, and
a step of forming a releasing layer on the aluminum surface layer.

The fixing device using a stainless steel material according to the second aspect of the present invention is characterized in that, in the first aspect, the base layer of the fixing member is either the base layer with a thickness of 20 μm to 50 μm of a fixing sleeve or the base layer with a thickness of 100 μm to 300 μm of a fixing roller, and the thickness of the aluminum surface layer is 15% to 50% of the base layer.

The fixing device using a stainless steel material according to the third aspect of the present invention is characterized in that, in the second aspect, the heating element is a halogen heater.

The fixing device using a stainless steel material according to the fourth aspect of the present invention is characterized in that, in the third aspect, the steps for forming the thin tubular fixing member further comprise a step of performing sandblasting of the outer peripheral surface of the tubular body of stainless steel material to roughen the outer peripheral surface as a step before the step of aluminum thermal spraying on the outer peripheral surface of the tubular body of stainless steel material.

The fixing device using a stainless steel material according to the fifth aspect of the present invention is characterized in that, in the fourth aspect, a maximum height roughness Rmax of the outer peripheral surface of the aluminum surface layer is no more than 40 μm.

The fixing device using a stainless steel material according to the sixth aspect of the present invention is characterized in that, in the fifth aspect, the steps for forming the thin tubular fixing member further comprise a step of polishing the outer peripheral surface of the tubular body of stainless steel material to remove convex portions thereof as a step after the step of aluminum thermal spraying on the outer peripheral surface of the tubular body of stainless steel material.

In the fixing device according to the present invention using a stainless steel material, a thin aluminum surface layer is formed on the outer peripheral surface of a tubular body made of a thin stainless steel material as a base layer, so that temperature rising speed in the thickness direction is high, temperature distribution is uniform in the axial direction with little thermal unevenness on the fixing member and less energy is required for heating the fixing member. Further, a halogen heater can be used as a heating element, heating of the fixing member can be made just after turning on of the power switch and stability of the device is improved along with less expense required, since the fixing member has a small heat capacity.

### BRIEF EXPLANATION OF DRAWINGS

FIG. 1 is an explanatory view showing a schematic composition of an image forming apparatus to which the fixing device according to the present invention is applied.

FIG. 2 is an explanatory sectional view showing the fixing device using a stainless steel material according to the present invention.

FIG. 3 is a flowchart showing the method for manufacturing the fixing member using a stainless steel material according to the present invention.

FIGS. 4(a) and 4(b) are views showing the method for manufacturing the fixing roller according to an embodiment of the present invention, in which FIG. 4(a) is a longitudinal sectional view showing a forming step of a cup-shaped tubular body by deep drawing and FIG. 4(b) is a perspective view showing the formed cup-shaped tubular body.

FIGS. 5(a) and 5(b) are views showing steps after FIGS. 4(a) and 4(b), in which FIG. 5(a) is an explanatory view showing a step of spinning the cup-shaped tubular body shown in FIG. 4(b) using a mandrel and FIG. 5(b) is a view showing a step of forming a tubular fixing roller by cutting off the cup-shaped tubular body after the spinning step at both ends thereof.

FIG. 6 is an explanatory view showing a step of sandblasting to the tubular fixing roller in which both ends have been cut off.

FIG. 7 is a view showing, as a step after FIG. 6, a step of thermally spraying aluminum on the tubular fixing roller in which both ends have been cut off.

FIGS. 8(a) and 8(b) are photographs showing the outer peripheral surface of the fixing roller on which aluminum is thermally sprayed, in which FIG. 8(a) is a photograph showing the whole outer peripheral surface of the fixing roller and FIG. 8(b) is an enlarged photograph showing the area surrounded by the rectangular frame line in FIG. 8(a).

FIG. 9 is microscopic photographs in magnification of five kinds showing three sites in FIGS. 8(a) and 8(b).

FIGS. 10(a), 10(b) and 10(c) are graphs showing the surface roughness measured at three sites on the fixing roller on which aluminum has been thermally sprayed, respectively.

FIG. 11 is a table showing data of the surface roughness shown in FIGS. 10(a), 10(b) and 10(c).

FIGS. 12(a), 12(b) and 12(c) are graphs showing the surface roughness measured at three sites on the fixing roller after polishing has been performed on the outer peripheral surface of the aluminum surface layer, respectively.

FIG. 13 is a table showing data of the surface roughness in FIGS. 12(a), 12(b) and 12(c).

FIG. 14 is an explanatory sectional view showing the fixing roller in a state where a releasing layer of fluorocarbon polymers has been formed on the outer peripheral surface of the aluminum surface layer.

### DETAILED EXPLANATION OF EMBODIMENTS

(General Explanation of an Image Forming Apparatus)

Embodiments of the present invention will be explained referring to drawings below.

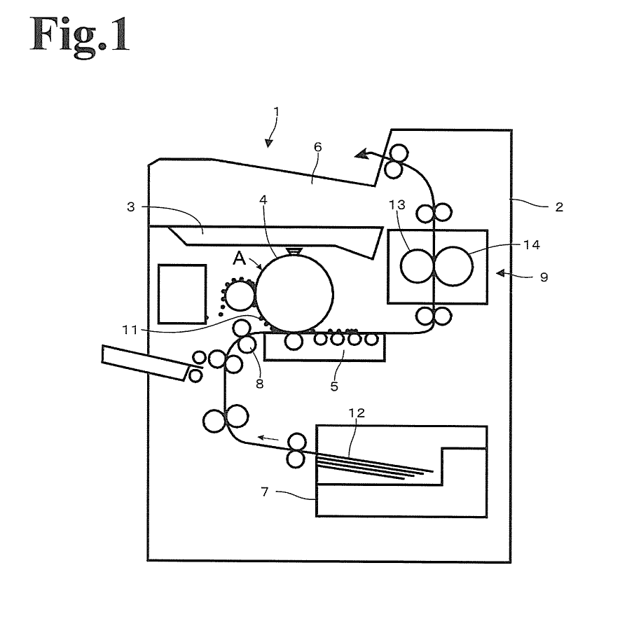

FIG. 1 is an explanatory view showing a schematic composition of an image forming apparatus to which the fixing device according to the present invention is applied. While the present invention relates to a fixing device 9, the composition of an image forming apparatus 1, to which the fixing device 9 is applied, is generally explained first. Various arrangements are known for the image forming apparatus 1. Here, exemplifying it for a laser printer as an image forming apparatus, the image forming apparatus 1 is composed of a main body 2, an exposure device 3, a photosensitive element 4, a transfer portion 5, a paper tray 6, a paper feeding portion 7, resist rollers 8, a fixing device 9, etc. Since the function and composition of each portion are known, detailed explanation is omitted here.

Next, operation of the image forming apparatus 1 will be explained generally. At the time of copying, laser beam light A carrying an image to be formed is irradiated in the exposure device 3 onto the photosensitive element 4. Steps of charge, exposure and development proceed as the drum mounting the photosensitive element 4 thereon is rotated, then toner image is formed with toner 11 on the photosensitive element 4. The toner 11 takes a form of particles, each of which contains coloring material and wax within it, and an image with such toner is formed on the photosensitive element 4 through the steps mentioned above. This image of toner is transferred, in the transfer portion 5 via transferring rollers provided to meet the photosensitive element 4, onto the paper 12 fed from the paper feeding portion 7 through the resist rollers 8.

The paper 12 having passed the transfer portion 5 is sent to the fixing device 9. The paper 12 is fed as sandwiched between a fixing roller 13 and a pressure roller 14 and a toner image is fixed on the paper 12 with heat and pressure. The paper 12 with fixing performed is sent as shown by an arrow to be ejected as a printed image to the paper tray 6. Copying with a laser printer is performed basically through the above mentioned steps.

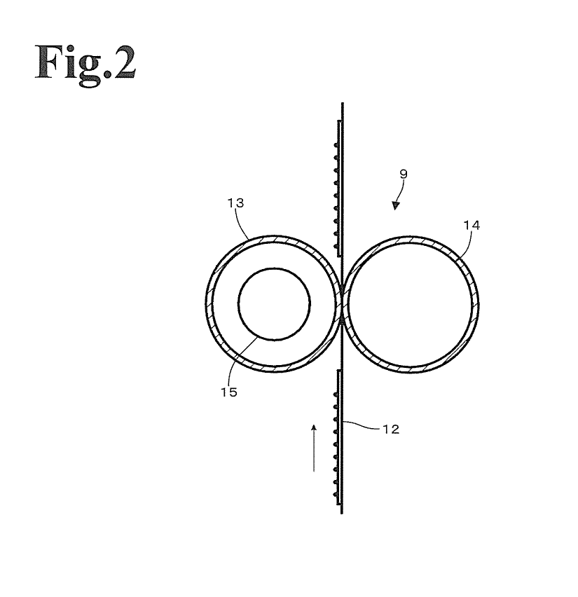

In the next, a fixing device 9 will be explained. FIG. 2 is an explanatory sectional view showing the fixing device using a stainless steel material according to the present invention. The fixing device 9 according to the present invention is basically composed of a fixing roller 13, a pressure roller 14, a halogen heater as a heating element 15, etc. This device is arranged so that the toner image on the paper 12 is fixed with the pressure roller 14 pressed to the thin tubular fixing roller 13. Explaining the fixing roller first, the fixing roller 13 is heated with the halogen heater as the heating element 15 disposed inside of the fixing roller 13.

The fixing roller (fixing member) 13 is formed of a stainless steel material as a base layer having a thickness of 100 μm to 300 μm. In place of the rather thick fixing roller 13, a fixing sleeve (a fixing film as a fixing member) formed of an extremely thin stainless steel material having a thickness of 20 μm to 50 μm may be employed. With such an extremely thin fixing sleeve, fixing with heating in quick start is possible by forming a nipped portion having a predetermined width between the pressure roller 14 and the heating element 15 and pressing the fixing sleeve with only the nipped portion heated.

(Manufacturing Method of the Fixing Roller)

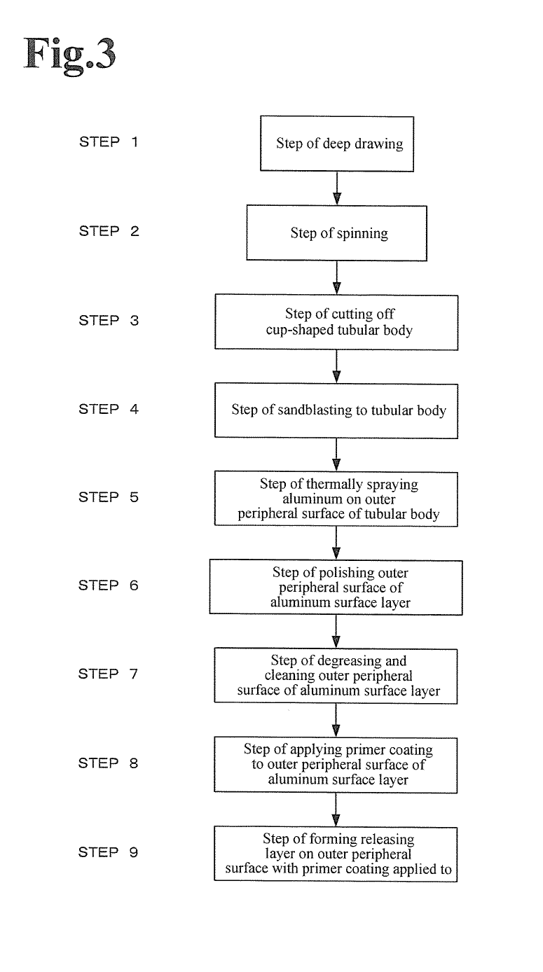

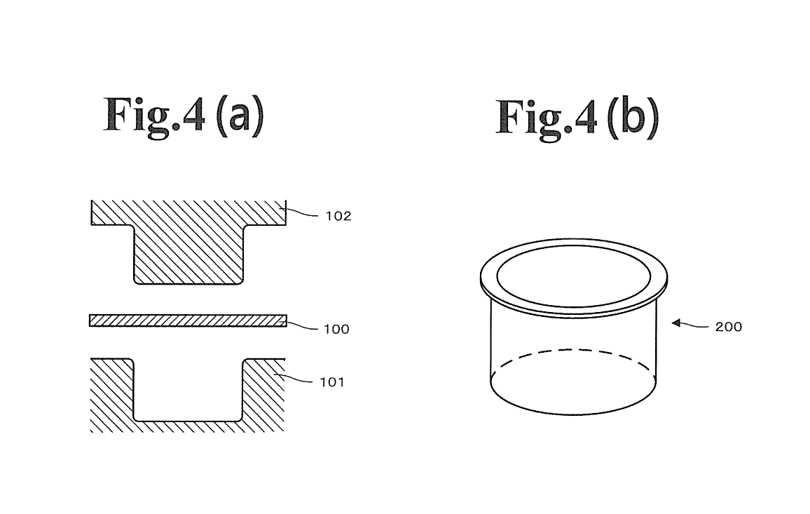

FIG. 3 is a flowchart showing the method for manufacturing the fixing member using a stainless steel material according to the present invention. FIGS. 4(a) and 4(b) shows the method for manufacturing the fixing roller according to an embodiment of the present invention, in which 4(a) is a lengthwise sectional view showing a forming step of a cup-shaped tubular body by deep drawing as STEP 1 in FIGS. 3 and 4(b) is a perspective view showing the formed cup-shaped tubular body 200. A fixing sleeve formed of an extremely thin stainless steel material with a thickness of 20 μm to 50 μm can be also manufactured in a similar method as a fixing roller. As shown in FIG. 4(a), a thin sheet 100 of stainless steel SUS304, etc., is worked by deep drawing with a female die 101 and a punch 102 to form a cup-shaped tubular body 200 as shown in FIG. 4(b).

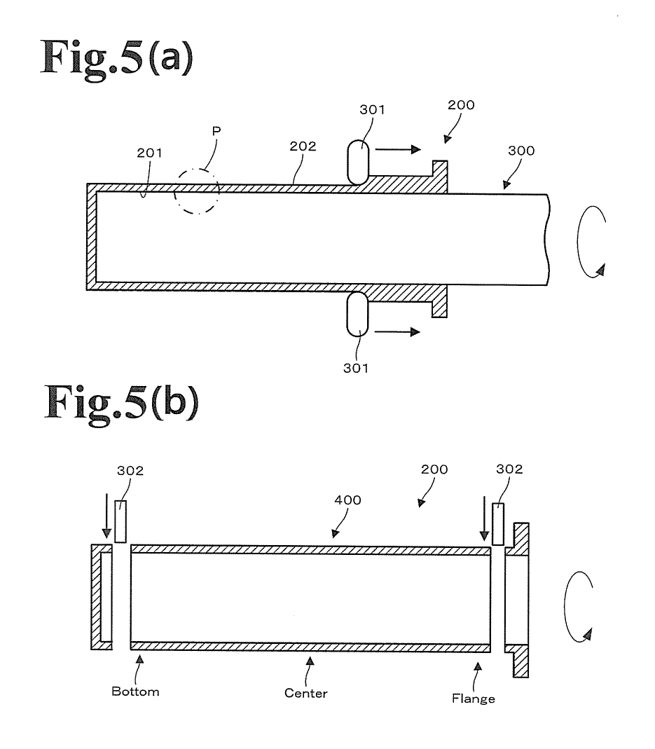

FIGS. 5(a) and 5(b) shows a step after one shown in FIGS. 4(a) and 4(b). Here, FIG. 5(a) is an explanatory view showing a step of spinning as STEP 2 in FIG. 3, that is, a step of spinning the cup-shaped tubular body 200 with a mandrel, and FIG. 5(b) is an explanatory view showing STEP 3 in FIG. 3, that is, a step of forming a tubular fixing roller by cutting off the cup-shaped tubular body 200 after the spinning step at both ends thereof. More particularly, the mandrel 300 of a spinning machine is fitted into the inner peripheral surface 201 of the cup-shaped tubular body 200 and the mandrel 300 is rotated to rotate the cup-shaped tubular body 200, as shown in FIGS. 5(a) and 5(b).

Working by spinning is performed by pressing rollers 301, 301 onto the outer peripheral surface 202 of the cup-shaped tubular body 200 and causing the rollers 301, 301 to move in the axial direction of the cup-shaped tubular body 200. With this, the cup-shaped tubular body 200 is subjected to plastic deformation in its axial direction to be thin and elongated in its axial direction. As shown in FIG. 5(b), cutting off the cup-shaped tubular body 200 having spinning finished at its both ends with cutting-off tools 302, 302, a tubular body 400 of a stainless steel material having a thickness of 100 μm to 300 μm as a base layer of the fixing roller 13 is obtained. It is also possible to form a tubular body 400 of a stainless steel material having a thickness of 20 μm to 50 μm that can be used as a fixing sleeve in a similar working by spinning.

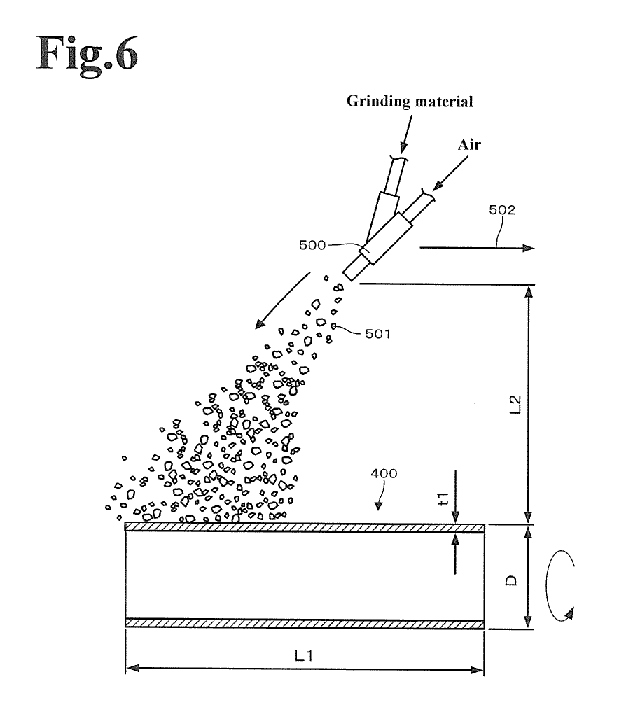

FIG. 6 shows a step after one shown in FIG. 5 as an explanatory view showing STEP 4 in FIG. 3, that is, a step of sandblasting to the tubular body 400 of a stainless steel material as a base layer. As shown in FIG. 6, the tubular body 400 of a stainless steel material as a base layer according to the embodiment of the present invention has such dimension as an outer diameter D of φ 20 mm, an axial length L1 of 258 mm and a thickness t1 of 100 μm. A sandblasting machine of a suction type is used for sandblasting such that grinding material 501 is of alumina #60, distance L2 of blasting is 200 mm, time of blasting is 30 seconds and air pressure is 0.4 MPa. Rotating the tubular body 400 of a stainless steel material as a base layer at 150 rpm, sandblasting was performed with the sandblasting nozzle 500 of the sandblasting machine being shifted in the direction parallel to the axial direction of the tubular body 400 (as shown by the arrow 502).

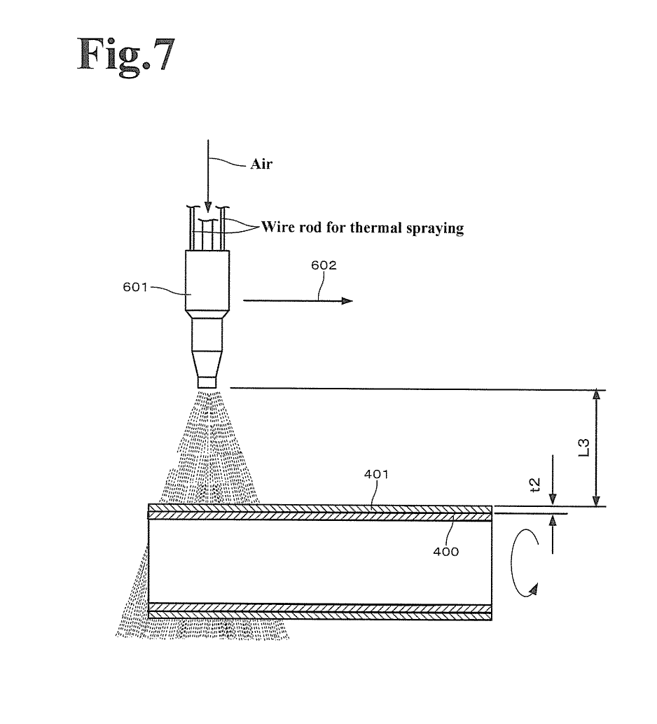

FIG. 7 shows a step after one shown in FIG. 6 as an explanatory view showing STEP 5 in FIG. 3, that is, a step of thermal spraying of aluminum on the outer peripheral surface of the tubular body 400 of a stainless steel material as a base layer. As shown in FIG. 7, an arc thermal spraying apparatus is used for thermal spraying such that material of a wire rod for thermal spraying is aluminum with purity of 99%, diameter of the wire rod is φ 1.2 mm, distance L3 of thermal spraying is 120 mm, shifting velocity of the spraying gun 601 is 20 mm/sec and air pressure is 0.5 MPa. Rotating the tubular body 400 of a stainless steel material as a base layer at 150 rpm, thermal spraying of aluminum was performed with the spraying gun 601 of the arc thermal spraying apparatus being shifted in the direction parallel to the axial direction of the tubular body 400 of a stainless steel material (as shown by the arrow 602). The thickness t2 of the thermally sprayed aluminum surface layer 401 is 20 μm to 30 μm. The aluminum to be thermally sprayed may be an aluminum alloy.

It is possible to form a reversed crown shaped aluminum surface layer 401 by varying the thickness t2 of the thermally sprayed aluminum surface layer 401 in the axial direction during thermal spraying. That is, by controlling the shifting velocity of the spraying gun 601 corresponding to the position in the axial direction on the tubular body 400 of a stainless steel material as a base layer (with the shifting velocity being gradually slower in the position near the both ends than in the position near the center portion in the axial direction), the aluminum surface layer 401 of the tubular body 400 of a stainless steel material as a base layer is formed so as to be thin in the central portion in the axial direction and to become gradually thicker towards the both ends in the axial direction. As a result, the central portion has a small heat capacity due to being thinner and the portions near to the both ends have a large heat capacity due to being thicker. Consequently, although the temperature in the central portion in the axial direction of the fixing roller 13 is lowered than in the portions at both ends through feeding paper, the temperature in the central portion in the axial direction of the fixing roller 13 can be raised in a short time since heat capacity of the portion is small. By virtue of this, thermal unevenness on the fixing roller 13 can be made less.

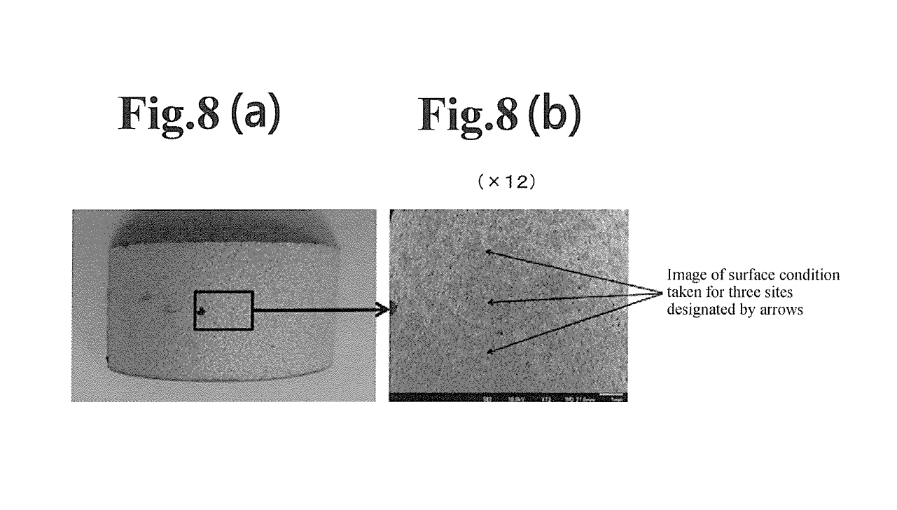

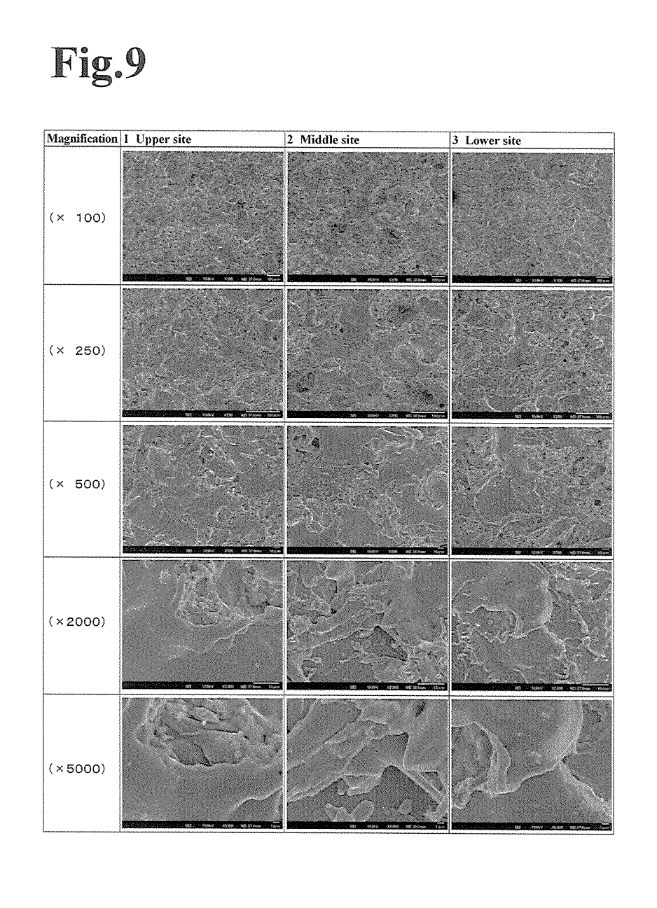

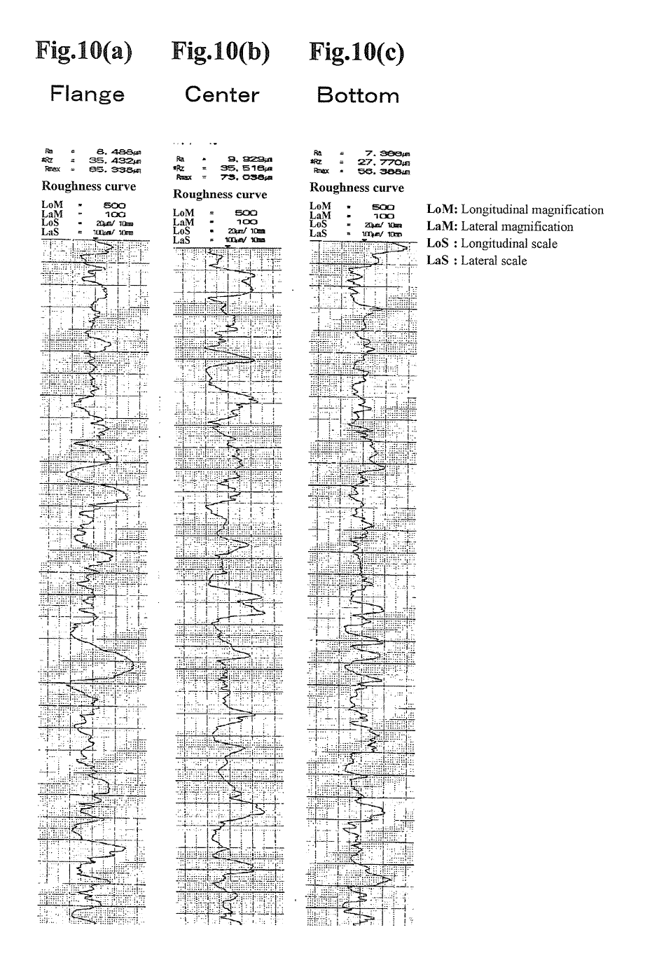

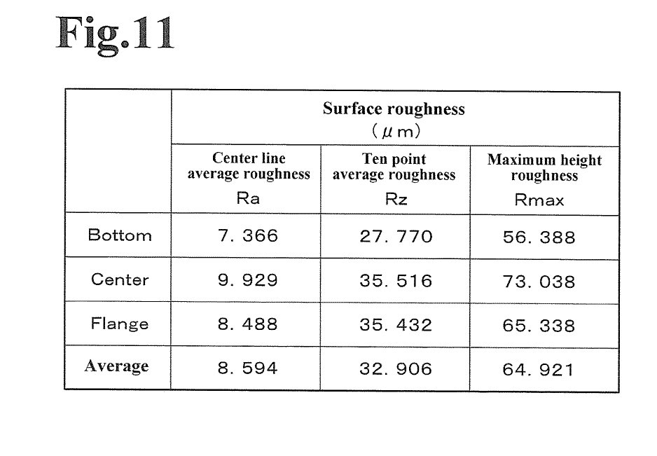

FIGS. 8(a) and 8(b) are photographs showing the outer peripheral surface of the fixing roller 13 on which aluminum is thermally sprayed, in which 8(a) is a photograph showing the whole outer peripheral surface of the fixing roller 13 and 8(b) is a photograph enlarged in a magnification of 12 times and showing the area surrounded by the rectangular frame line in 8(a). FIG. 9 is microscopic photographs in magnification of five kinds showing three sites in FIGS. 8(a) and 8(b). FIGS. 10(a), 10(b) and 10(c) are graphs showing the surface roughness measured at three sites, that is, at Flange, Bottom and Center on the fixing roller on which aluminum is thermally sprayed, respectively. FIG. 11 is a table showing data of the surface roughness shown in FIGS. 10(a), 10(b) and 10(c). As seen from the state of the formed cup-shaped tubular body 200 as shown in FIG. 5(a), FIG. 5(b), the open end side is called as Flange, the bottom side is called as Bottom and the intermediate portion between the open end side and the bottom side is called as Center. As seen in FIGS. 10(a), 10(b) and 10(c) and 11, the outer peripheral surface of the fixing roller 13 on which aluminum has been thermally sprayed has a surface roughness such that Ra (Center line average roughness) is 7.366 μm to 9.929 μm, Rz (Ten point average roughness) is 27.770 μm to 35.516 μm and Rmax (Maximum height roughness) is 56.388 μm to 73.038 μm.

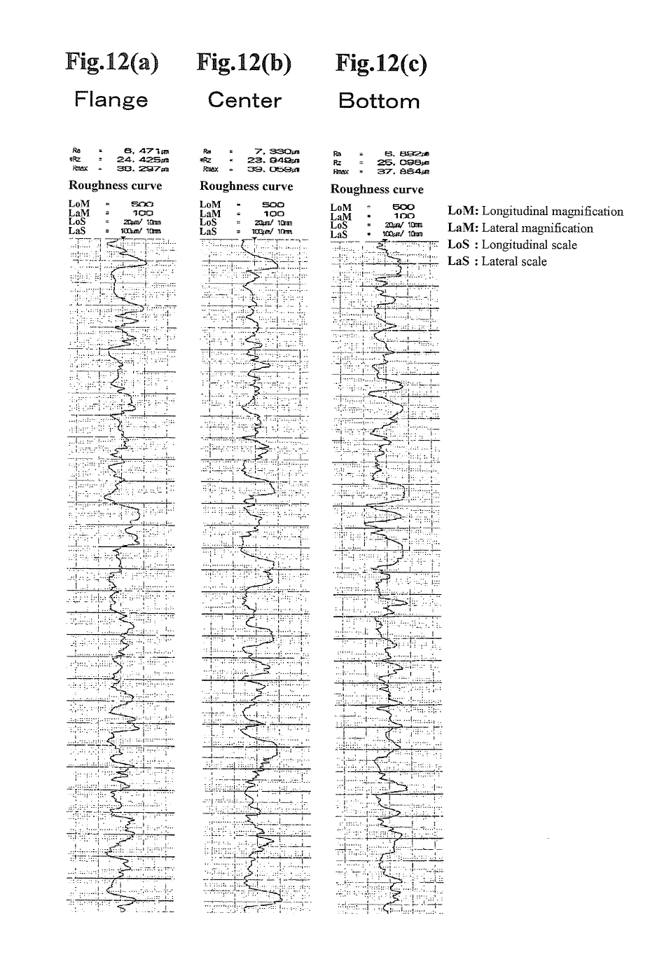

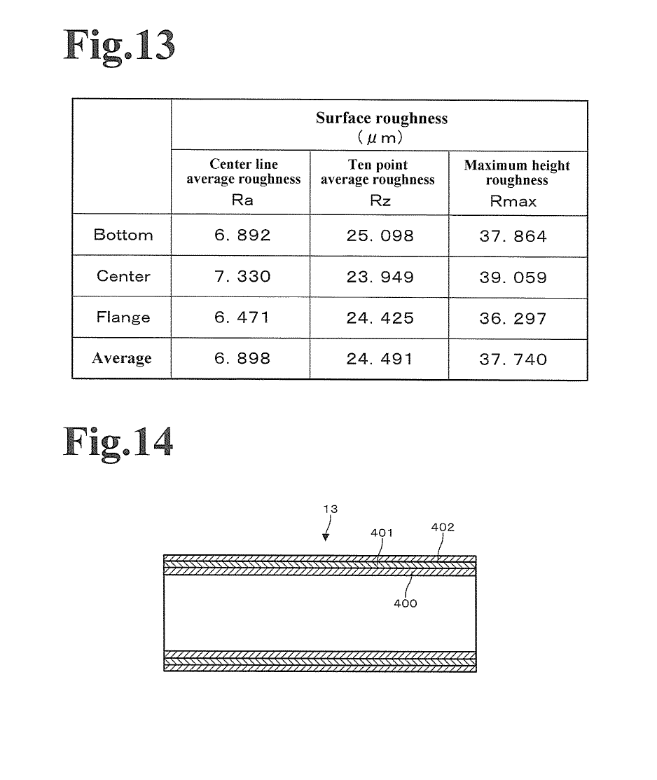

In the next, the outer peripheral surface of the fixing roller 13 on which aluminum has been thermally sprayed is polished in STEP 6 shown in FIG. 3. Rotating the fixing roller 13 along with shifting a polishing tool in the direction parallel to the axial direction of the fixing roller 13, the convex portions on the outer peripheral surface of the fixing roller are removed away to smooth the outer peripheral surface of the aluminum surface layer. FIGS. 12(a), 12(b) and 12(c) are graphs showing the surface roughness measured at three sites, that is, at Flange, Bottom and Center, on the outer peripheral surface of the aluminum surface layer 401 after polishing has been performed, respectively, and FIG. 13 is a table showing the data of the surface roughness in FIGS. 12(a), 12(b) and 12(c). As shown in FIGS. 12(a), 12(b) and 12(c) and 13, the outer peripheral surface of the fixing roller 13 having been subjected to polishing has a surface roughness such that Ra (Center line average roughness) is 6.892 μm to 7.330 μm. Rz (Ten point average roughness) is 23.949 μm to 25.098 μm and Rmax (Maximum height roughness) is 36.297 μm to 39.059 μm. The convex portions on the outer peripheral surface of the fixing roller 13 are removed away by polishing so that irregularities in the fluorocarbon polymers or silicone rubber to be coated in the later step become small. That is, the surface roughness in the outer peripheral surface of the aluminum surface layer by Rmax (Maximum height roughness) is preferable to be no more than 40 μm, specifically preferable to be 10 μm to 40 μm.

Next, the outer peripheral surface of the aluminum surface layer 401 of the fixing roller 13 having been polished is degreased and cleaned in STEP 7 shown in FIG. 3. Primer coating is applied, with a spraying gun, to the outer peripheral surface of the aluminum surface layer 401 that has been degreased and cleaned in STEP 8 shown in FIG. 3. Water-based paint containing polytetrafluoroethylene resin as a main component was used for primer. STEP 9 shown in FIG. 3 is the last step, in which the outer peripheral surface to which primer coating has been applied is coated with elastic material such as silicone rubber or fluorocarbon polymers having releasing property by use of a spraying gun to form a releasing layer (surface layer) 402. With this step, the fixing roller 13 is accomplished, which affords uniform fixing of toner 11 following the paper 12 and improvement in releasing property.

(Thickness of Aluminum Surface Layer)

The outer peripheral surface of the tubular body of a stainless steel material is covered with an aluminum surface layer formed by thermal spraying. The thickness t2 of this aluminum surface layer 401 is 20 μm to 30 μm in the above mentioned embodiment. In the case where the thickness of the aluminum surface layer is thin compared with the tubular body of a stainless steel material, the effect of restraining temperature rise in the end portions becomes less. The following table 1 shows a result obtained by measuring temperature rise in the end portions with the thickness of the aluminum surface layer fixed to be 30 μm and the thickness of the tubular body of a stainless steel material being varied.

TABLE 1
Temperature at ends and thickness of base layer in fixing roller

| SUS | Al | Ratio | Temerature | |
|---|---|---|---|---|
| (μm) | (μm) | (%) | rise in ends | Decision |
| 150 | 30 | 20 | low | OK |
| 200 | 30 | 15 | low | OK |
| 250 | 30 | 12 | high | NG |

From this result, it is clarified that the temperature in the end portions becomes high when the ratio of the thickness of the aluminum surface layer to that of the tubular body of a stainless steel material is 12%. It is necessary for the thickness of the aluminum surface layer to be 10 μm or more, since cavity occurs when the thickness is less than 10 μm. The thickness of aluminum surface layer is more preferable to be more than 20 μm. In general, the thickness of the tubular body of a stainless steel material as a base layer of a fixing sleeve is 20 μm to 50 μm, considering mechanical strength and heat capacity. Similarly considering, the thickness of the tubular body of a stainless steel material as a base layer of a fixing roller is 100 μm to 300 μm in general. Consequently, considering the maximum thickness of the base layer of the fixing roller as being about 300 μm, it may be sufficient for the thickness of the aluminum surface layer to be more than 15% in ratio to that of the base layer of a stainless steel material, as seen from Table 1. However, too much thickness brings a waste of materials. Since the thickness of the base layer of a stainless steel material of a fixing roller is about 300 μm at most, the maximum thickness of the aluminum surface layer, being at most 50% of the base layer of a stainless steel material, is restricted to 150 μm.

From these, it is suitable that the thickness of the aluminum surface layer of a fixing roller or a fixing sleeve is in the level of 10 μm to 150 μm. Preferably, the thickness of the aluminum surface layer is 20 μm to 25 μm for a fixing sleeve and 10 μm to 150 μm for a fixing roller. To say this thickness of the aluminum surface layer by the ratio to the thickness of the stainless steel material as a base layer, it is suitable for the aluminum surface layer to be 15% to 50% of the thickness of the stainless steel material as a base layer.

In the fixing device according to the present invention using a stainless steel material, a thin aluminum surface layer is formed on the outer peripheral surface of a tubular body made of a thin stainless steel material as a base layer, so that temperature rising speed in the thickness direction is high, temperature distribution is uniform in the axial direction with little thermal unevenness on the fixing member and less energy is required for heating the fixing member. Further, a halogen heater can be used as a heating element, heating of the fixing member can be made just after turning on of the power switch and stability of the device can be provided along with less expense required, since the fixing member has a small heat capacity. While examples where a halogen lamp is used as a heating element has been explained for embodiments, other heating elements such as a ceramic heater, an electromagnetic induction coil, etc.

What is claimed is:

1. A fixing device using a stainless steel material for heating toner to fix toner images on recording media in an image forming apparatus in which copying is performed through toner;
the fixing device being equipped with a thin tubular fixing member heated by a heating element disposed therein, and
the thin tubular fixing member being formed through:
a step of forming a cup-shaped tubular body of stainless steel material having a thickness of 20 μm to 300 μm by fitting a mandrel into an inner peripheral surface of the cup-shaped tubular body of stainless steel material and performing spinning with a roller/rollers pressed and shifted in the axial direction during rotation of the cup-shaped tubular body to elongate the cup-shaped tubular body in the axial direction,
a step of cutting off both ends of the cup-shaped tubular body to form a tubular body of stainless steel material as a base layer,
a step of aluminum thermal spraying on an outer peripheral surface of the tubular body of stainless steel material to form an aluminum surface layer having a thickness of 10 μm to 150 μm thereon, and
a step of forming a releasing layer on the aluminum surface layer.

2. The fixing device using a stainless steel material according to claim 1,
wherein the base layer of the fixing member is either the base layer with a thickness of 20 μm to 50 μm of a fixing sleeve or the base layer with a thickness of 100 μm to 300 μm of a fixing roller, and
the thickness of the aluminum surface layer is 15% to 50% of the base layer.

3. The fixing device using a stainless steel material according to claim 2,
wherein the heating element is a halogen heater.

4. The fixing device using a stainless steel material according to claim 3,
wherein the steps for forming the thin tubular fixing member further comprise a step of performing sandblasting of the outer peripheral surface of the tubular body of stainless steel material to roughen the outer peripheral surface as a step before the step of aluminum thermal spraying on the outer peripheral surface of the tubular body of stainless steel material.

5. The fixing device using a stainless steel material according to claim 4,
wherein a maximum height roughness Rmax of the outer peripheral surface of the aluminum surface layer is no more than 40 μm.

6. The fixing device using a stainless steel material according to claim 5,
wherein the steps for forming the thin tubular fixing member further comprise a step of polishing the outer peripheral surface of the tubular body of stainless steel material to remove convex portions thereof as a step after the step of aluminum thermal spraying on the outer peripheral surface of the tubular body of stainless steel material.
